(19) United States
(12) Patent Application Publication
(10) Pub. No.: US 2020/0155280 A1
(43) Pub. Date: May 21, 2020

(54) GINGIVAL RETRACTION DEVICE WITH IMPRESSION AND METHOD OF USE

(71) Applicant: Centrix, Inc., Shelton, CT (US)

(72) Inventor: Pengguang YU, Branford, CT (US)

(21) Appl. No.: 16/751,389

(22) Filed: Jan. 24, 2020

Related U.S. Application Data
(63) Continuation of application No. PCT/US2018/045529, filed on Aug. 7, 2018.
(60) Provisional application No. 62/544,955, filed on Aug. 14, 2017.

(51) Int. Cl. A61C 9/00

(52) U.S. Cl. CPC A61C 9/0006; A61C 9/0033

(57) ABSTRACT

Simultaneously retracting gingiva and taking an impression around a tooth with two different materials having different setting properties with different viscosities or rigidity. A supportive material having a higher viscosity or rigidity relevant to an impression material is used in combination with a rigid tray to retract gingiva and form an impression of and around a tooth. The timing of the application of pressure to the tray when placed over a tooth containing the two different materials is such that pressure is only applied when the supportive material has a state of cure or setting state with a viscosity or rigidity greater than the state of cure or setting state of the impression material.

### RELATED APPLICATIONS

This application is a continuation of International Application PCT/US2018/045529, with an international filing date of Aug. 7, 2018, which claims the benefit of U.S. Provisional Application Nos. 62/544,955 filed Aug. 14, 2017, all of which are herein incorporated by reference.

### FIELD OF THE INVENTION

The present invention relates in general to gingival retraction as used in dentistry, and particularly to performing retraction simultaneously with forming an impression of a tooth and surrounding gingiva.

### BACKGROUND OF THE INVENTION

In dentistry when making a crown or bridge it is often necessary to retract the gingival from around a prepared tooth before the taking of an impression. A good impression is often critical to a well-fitting crown or bridge. A good impression can only be achieved with retraction of the gingiva to expose the tooth line. Accordingly, there have been many efforts to improve retraction and the taking of impressions.

One such retraction system is disclosed in U.S. Pat. No. 5,676,543 entitled “Gum Tissue Retraction Device and Method” issuing to Dragan on Oct. 14, 1997, which is herein incorporated by reference. Therein disclosed is a moldable material formed over a tooth with a flowable material containing an astringent placed in the moldable material providing retraction and hemostasis at the gum line.

Another retraction system is disclosed in U.S. Pat. No. 8,470,905 entitled “Gingival Tissue Retraction Device and Method” issuing to Dragan et al. on Jun. 25, 2013, which is herein incorporated by reference. Therein disclosed is a cordless retraction system using a cap or dam filled with a heavy viscous material placed over a tooth. When pressure is applied onto the tooth dam, the retraction material is displaced under pressure and forced into the sulcus causing gingival tissue retraction.

While these prior retraction systems have worked for their intended purpose a multiple step process for retraction and impression taking is still required. Therefore there is a need for an improved retraction device and method that provides retraction and an improved impression that is easier to take and requires less time.

### SUMMARY OF THE INVENTION

The present invention uses two different materials having different setting properties with different viscosities or rigidity to simultaneously retract gingiva and take an impression around a tooth. A supportive material having a higher viscosity or rigidity relevant to an impression material is used in combination with a rigid tray to retract gingiva and form an impression of and around a tooth. The timing of the application of pressure to the tray when placed over a tooth containing the two different materials is such that pressure is only applied when the supportive material has a state of cure or setting state with a viscosity or rigidity greater than the state of cure or setting state of the impression material. Due to the higher viscosity or rigidity of the supportive material, the impression material is contained within the supportive material and the impression material is forced into a gingival sulcus around a tooth.

Accordingly, it is an object of the present invention to simultaneously retract the gingiva around a tooth, opening a gingival sulcus, and to take an impression thereof.

It is an advantage of the present invention that an impression of the tooth and surrounding gingival sulcus can be taken quickly and effectively in a single step.

It is a feature of the present invention that the application of pressure to a tray containing the supportive material and the impression material is timed, when placed over a tooth, so that the supportive material has rigidity greater than the impression material.

These and other objects, advantages, and features will become more readily apparent in view of the following detailed description.

### BRIEF DESCRIPTION OF THE DRAWINGS

FIG. 1 schematically illustrates a tooth, gingiva, and a gingival sulcus.

FIG. 2A schematically illustrates a first step in practicing the present invention.

FIG. 2B schematically illustrates a second step in practicing the present invention.

FIG. 3 is a graph illustrating a timing sequence in practicing the present invention.

FIG. 4 is a graph illustrating another timing sequence in practicing the present invention.

### DETAILED DESCRIPTION OF THE PREFERRED EMBODIMENTS

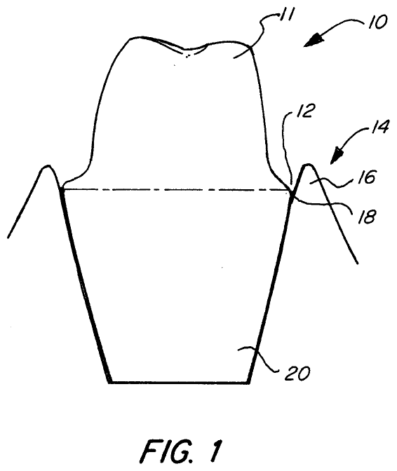

FIG. 1 illustrates a tooth 10 having a core 11 and root 20. The core 11 is typically a portion of the tooth 10 prepared for placement of a crown thereon. Gingiva 14 surrounds the root 20 and core 11. A gingival sulcus 12 is formed between the root 20 and the gingiva 14. The sulcular epithelium 16 lines the gingival sulcus 12. The junctional epithelium 18 is at the base of the gingival sulcus 12. Often in taking an impression of the tooth and core 11 in preparation for a crown to be placed over the tooth 10, it is often necessary to open the gingival sulcus 12 and retract the gingiva 14.

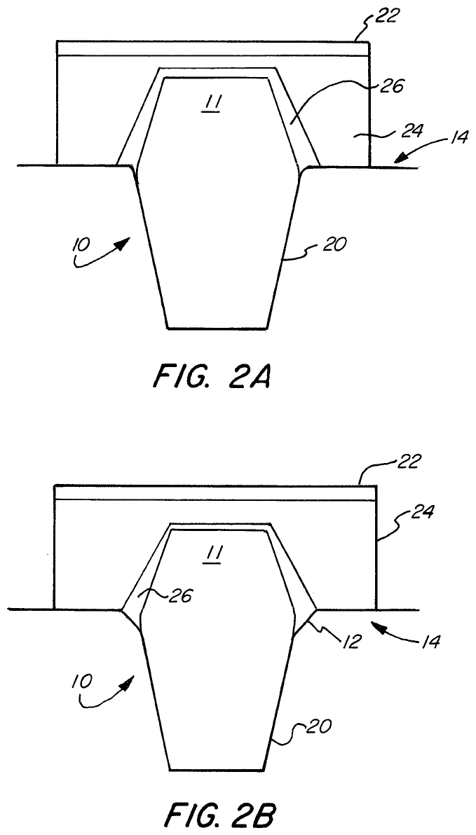

FIGS. 2 A-B schematically illustrates the present invention. A tray 22 or supportive structure is filled with a tray or supportive material 24. A wash or impression material 26 is placed over the supportive material 24 in the tray and may also be placed over the core 11. The supportive material 24 and the impression material 26 are typically polymer materials and initially flow and are chemically cured or set so as to become rigid, but flexible so as to form a mold or impression of the core 11 and gingival sulcus 12. The curing or setting properties of each of the supportive or impression materials may be adjusted with a catalyst. Some supportive or impression materials may also be light cured.

FIG. 2A illustrates an initial step 1 where the impression material 26 and the supportive material 24 are placed over the core 11 of the tooth 10. A tray 22 containing the supportive material 24 and the impression material 26 holds the two materials 24 and 26 around the core 11. The tray 22 preferably has sides to help contain the two materials 24 and 26. In this step 1, the supportive material 24 is caused to reach a state of cure or setting state having a viscosity or rigidity greater than the state of cure or setting state of the impression material 26.

FIG. 2B illustrates a subsequent step 2 where pressure is applied to the tray 22 while the impression material 24 is in a state of cure or setting state having a viscosity or rigidity less than the state of cure or setting state of the supportive material 24. Pressure may be applied to tray 22 until the impression material reaches a substantially fully cured state or in which the impression material 24 no longer has the ability to adequately flow.

Accordingly, by adjusting the timing between the initial step 1, illustrated in FIG. 2A, and the application of pressure to the tray 22, illustrated in FIG. 2B, based on the relative state of cure of the two materials, the impression material 26 is more effectively forced into the gingival sulcus 12 resulting in improved gingiva retraction and a good impression taken in a shorter time.

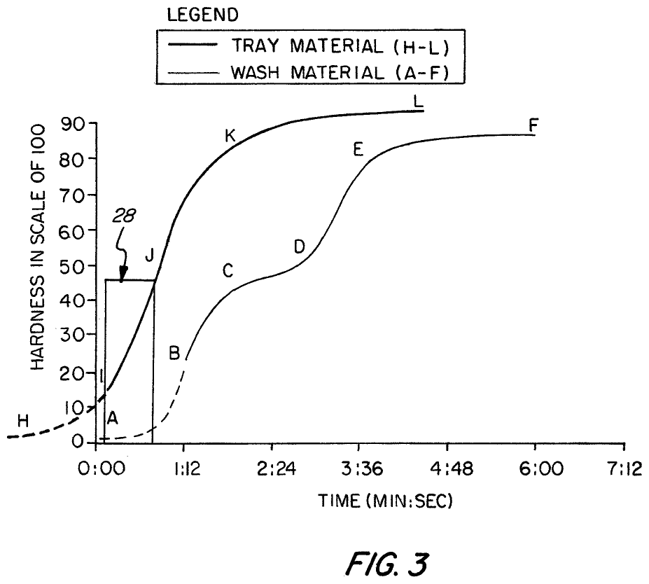

FIG. 3 graphical illustrates the relationship in the state of cure or setting state of the tray or supportive material and the wash or impression material. Box 28 identifies a window in time or period of time that provides optimum gingiva retraction and the taking of a good impression. The relative state of cure or setting of the supportive material is illustrated as points H to L along the upper curved. The relative state of cure or setting of the impression material is illustrated as points and A to F of the lower curve. Generally over time both the supportive material and the impression material cure, set, and become harder or more rigid.

For the impression material, points A to B representing a muddy stage or harness that cannot be measured using a durometer. Points B to C represent a flowable and reshapable phase. Points C to D represents a slowing and transition to becoming permanent or solid. Points D to E represent where the material is no longer flowable and a shape is maintained even though the material is flexible. Points E to F represent when the material is hardened and polymerization is fully complete.

For the supportive material, points H to I representing a muddy stage or harness that cannot be measured using a durometer. Points I to J represent a flowable and reshapable phase. Points J to K represents were the material is no longer flowable and a shape is maintained even though the material is flexible. Points K to L represent where the material is hardened and polymerization is fully complete.

As illustrated in FIG. 3 the optimum time for applying pressure to the tray containing both materials is while the supportive material is relatively rigid but is still flowable and reshaped and where the impression material is in a muddy stage or flowable and less viscous than the supportive material at the same point in time. This permits the supportive material to provide support and entrap the impression material pushing it into the gingival sulcus causing retraction while simultaneously forming an impression. A time beyond point J results in the supportive material becoming no longer flowable, reducing its ability to adequately adjust for the movement of the impression material so as to apply a suitable force.

As illustrated in FIG. 3 this window in time, period of time, or common time in which pressure is optimally applied can be achieved by initiating curing in the supportive material prior to initiating curing in the impression material. The different relative curing may also be achieved by chemically adjusting the catalyst of the two materials such that the supportive material cures at a first predetermined rate to provide the required support to the impression material and the impression material cues at a second predetermined rate to be sufficiently flowable to open the gingival sulcus.

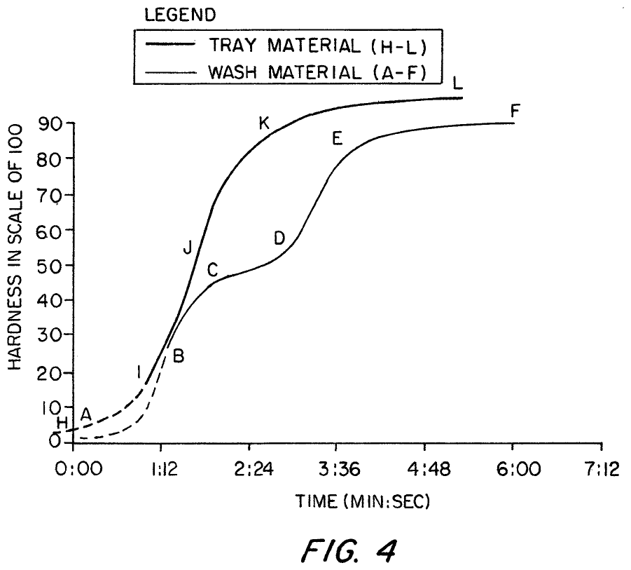

FIG. 4 graphical illustrates another relative state of cure or setting state of the two materials. In FIG. 4 the time between initiating cure in the two materials is shortened or less than in FIG. 3 resulting in a smaller window in time, period of time, or common time in which pressure may be applied to be effective. Therefore, to provide a longer window in time, period of time, or common time in which to apply pressure, curing may be initiated in the supportive material earlier than initiating curing in the impression material. Initiating cure in the supportive material 30 to 60 seconds prior to initiating cure in the impression material has been determined to provide an adequate window in time, period of time, or common time in practice. The window in time should be as long as possible, and preferably is between 30 to 120 seconds.

In practicing the present invention, referring to FIG. 3, a dental tray with the supportive material therein and preferably with the impression material therein, is placed over a tooth. The impression material may also be additionally pre-applied around the tooth and gingiva. After placing the tray over the tooth a first initial light pressure may be applied by gently biting down on the tray. This light pressure should only occur between the period of time between point H and point I. When the supportive material is at a state of cure or setting state between points I and J a subsequent harder biting pressure should be applied by firmly biting down on the tray. To be most effective the hard biting pressure should occur during a time before point B when the impression material is still sufficiently flowable so as to be forced into the gingival sulcus. This improves gingival retraction and results in a good impression.

Accordingly, the supportive material acts as a dam and is rigid enough to contain the impression material under pressure, yet fluid enough so as to adjust in applying continuous pressure to the gingival sulcus.

The impression material may contain an astringent or hemostasis reagent, such as aluminum sulfate or ferric sulfate to aid in the retraction of the gingiva. The impression material may also contain a hydrophilic material to absorb excess fluid from around the tooth. The hydrophilic material may be a polymer, such as sodium polyacrylate, aquadiomonds; mineral porous powder such as perlite, vermiculite, zeolite, or silica gel; or other absorption or hydrophilic material. The impression material may also contain a caries indicator, such as a silver diamine. These materials may be held within an emulsion. The emulsion may contain a pre-determined concentration of agent or material that when released is immediately available to the tissue.

Preferably the impression material may contain an anhydrous astringent reagent, such as anhydrous aluminum sulfate. By removing water molecules from the aluminum sulfate crystal structure, adaptation to a silicon based carrier is improved.

The impression material and the supportive material should have consistent setting times and characteristics so that the working window of time in which the supportive material is sufficiently rigid and flowable to force the impression material into the sulcus around the tooth is easily determined. Different working times may be obtained by varying the setting or polymerizing time of the impression material relative to the supportive material. The supportive material should have a viscosity or rigidity greater than the impression material and yet be flowable during the working window of time. During the working window of time, defined as the period of time during which the supportive material has a state of set with a flowable viscosity or rigidity greater than the flowable viscosity or rigidity of the impression material, pressure is applied to the tray pushing downward on the prepared tooth and gingiva. After the working window of time and the supportive material and impression material have set, the tray with the set supportive material and impression material are removed from the prepared tooth and gingiva. The resulting impression mold is used to fabricate a crown or other restorative to be placed over the prepared tooth. The supportive material and impression material may comprise well known silicone based materials, or a vinyl polysiloxane or VPS.

The present invention makes possible the retraction of gingiva and the taking of an impression of a prepared tooth in a single procedure or step. The present invention advances the art and makes dentistry easier.

What is claimed is:

1. A dental device retracting gingiva from around a tooth and taking an impression for use in dentistry comprising:
a supportive structure;
a supportive material having a first predetermined setting time to a first setting state for placement in said supportive structure;
an impression material having a second predetermined setting time to a second setting state for placement adjacent said supporting material; and
wherein the first setting state of said supportive material has a rigidity greater than the second setting state of said impression material during a common time,
whereby said supportive material is capable of containing said impression material adjacent the gingiva and the tooth retracting the gingiva and forming an impression.

2. A dental device retracting gingiva from around a tooth and taking an impression as in claim 1 further comprises:
an astringent agent placed in said impression material.

3. A dental device retracting gingiva from around a tooth and taking an impression as in claim 1 further comprises:
a hemostatic agent placed in said impression material.

4. A dental device retracting gingiva from around a tooth and taking an impression as in claim 1 further comprises:
a hydrophilic agent placed in said impression material.

5. A dental device retracting gingiva from around a tooth and taking an impression as in claim 1 wherein:
said supportive material and said impression material are chemically cured.

6. A dental device retracting gingiva from around a tooth and taking an impression as in claim 1 wherein:
the common time ranges between 30 and 120 seconds.

7. A dental device retracting gingiva from around a tooth and taking an impression of a tooth and gingiva comprising:
an impression material having a first rigidity during a first working time, whereby said impression material is capable of being placed around a tooth;
a supportive material having a second rigidity during a second working time, whereby said supportive material is capable of being placed over said impression material; and
wherein from the first working time and the second working time a working window of time is formed in which the first rigidity is less than the second rigidity and said impression material and said supportive material are flowable,
whereby when said supportive material is placed over said impression material and pressure is applied, said supportive material is sufficiently rigid and flowable to force the impression material into a sulcus around the tooth.

8. A dental device retracting gingiva from around a tooth and taking an impression of a tooth and gingiva as in claim 7 further comprising:
a supportive structure, said supportive material being placed in said supportive structure.

9. A dental device retracting gingiva from around a tooth and taking an impression of a tooth and gingiva as in claim 7 wherein:
said supportive structure comprises a dental tray.

10. A method of retracting gingiva from around a tooth and taking an impression comprising the steps of:
placing a supportive material having a first predetermined setting time to a first setting state in a supportive structure;
placing an impression material having a second predetermined setting time to a second setting state on the supportive material;
positioning the impression material, supportive material, and the supportive structure over a tooth; and
applying pressure to the supportive structure while the first setting state of said supportive material has a rigidity greater than the second setting state of said impression material,
whereby said supportive material is capable of containing said impression material adjacent the gingiva and tooth opening a gingival sulcus and forming an impression.

11. A method of retracting gingiva from around a tooth and taking an impression as in claim 10 further comprising the step of:
placing an astringent agent around the tooth and gingiva prior to said step of positioning the impression material, supportive material, and the supportive structure over the tooth.

12. A method of retracting gingiva from around a tooth and taking an impression as in claim 11 wherein:
the impression material comprises an astringent.

13. A method of retracting gingiva from around a tooth and taking an impression as in claim 11 further comprising the step of:
placing additional impression material around the tooth and gingiva prior to said step of positioning the impression material, supportive material, and the supportive structure over the tooth.

14. A method of retracting gingiva from around a tooth and taking an impression as in claim 11 wherein:
the supportive material is flowable and reshapable during said step of applying pressure to the supportive structure.

15. A gingival retraction and impression kit comprising:
a supportive structure;
a supportive material;
an impression material; and
wherein a curing rate of said supportive material provides a rigidity greater than a curing rate of said impression material over a working window of time,
whereby said supportive material is capable of containing said impression material when pressure is applied to said supportive structure containing said supportive material and said impression material.
